(19) United States
(12) Patent Application Publication
(10) Pub. No.: US 2015/0327714 A1
(43) Pub. Date: Nov. 19, 2015

(54) Hot Beverage Maker and Beverage Vessel with Beverage Level Indicator

(71) Applicant: SUNBEAM PRODUCTS, INC., Boca Raton, FL (US)

(72) Inventor: Eric Forti, Boynton Beach, FL (US)

(73) Assignee: Sunbeam Products, Inc., Boca Raton, FL (US)

(21) Appl. No.: 14/760,895

(22) PCT Filed: Jan. 14, 2014
(86) PCT No.: PCT/US14/11494

§ 371 Date: Jul. 14, 2015

Related U.S. Application Data
(60) Provisional application No. 61/752,060, filed on Jan. 14, 2013.

(51) Int. Cl. A47J 31/44; A47J 31/46

(52) U.S. Cl. CPC A47J 31/4457; A47J 31/46

(57) ABSTRACT

A beverage maker is provided comprising a housing, a brew head disposed in the housing, a beverage vessel configured to be removably inserted into a recess in the housing and having an interior volume where beverage brewed by the brew head is directed, a removable lid that fits into an opening of the beverage vessel leading to the interior volume, and indicia in the cover configured to display a level of beverage inside the interior volume of the beverage vessel. A hole is provided in the lid where beverage brewed by the brew head flows through before the beverage is directed to the interior volume of the beverage vessel. The indicia includes a plurality of adjacently staggered light tubes of varying length extending downwardly from the lid into the interior volume of the beverage vessel and configured to sense and graphically display the level of be erase within the interior volume.

### RELATED APPLICATIONS

This application claims priority to U.S. provisional patent application No. 61/752,060 filed on Jan. 14, 2013.

### FIELD OF THE INVENTION

The present invention relates to a beverage maker, and more particularly, to a hot beverage maker and beverage vessel having a beverage level indicator comprised of a plurality of light tubes.

### BACKGROUND OF THE INVENTION

Hot beverages such those made from coffee such as cappuccino, espresso and latte have become very popular. More recently, consumers have had a desire to eliminate the inconvenience of having to go to specialty coffee houses to buy these beverages and to make these hot beverages at home. Many of the current hot beverage makers of this type adapted for home use do not have a thermal carafe where the brewed beverage is dispensed to keep the hot beverage warm. Since thermal carafes of this type typically have insulated, non-transparent walls the level of the brewed beverage inside can't be seen without removing the carafe from the main housing and removing the lid to see the level of liquid. Moreover, removing the lid to ascertain the liquid level allows precious heat to escape from within the thermal carafe leading to a premature cooling of the hot beverage inside possibly wasting the hot beverage.

### SUMMARY OF THE INVENTION

In an embodiment, there is provided beverage maker comprising a housing, a brew head disposed in the housing, a beverage vessel configured to be removably inserted into a recess in the housing and having an interior volume where beverage brewed by the brew head is directed, a removable lid that fits into an opening of the beverage vessel leading to the interior volume, and indicia in the cover configured to graphically display a level of beverage inside the interior volume of the beverage vessel.

In an embodiment, there is provided a hot beverage maker comprising a housing, a brew head disposed in the housing configured to brew a hot beverage, a thermally insulated beverage vessel configured to be removably inserted into a recess in the housing and having an interior volume where the hot beverage brewed by the brew head is directed, a removable lid that fits into an opening of the beverage vessel leading to the interior volume, and indicia in the cover configured to graphically display a level of beverage inside the interior volume of the beverage vessel.

In an embodiment, there is provided a beverage vessel, comprising a bottom wall, an annular sidewall extending from the bottom wall and ending in an annular opening leading to an interior volume where beverage is stored for further dispensing, a removable lid that fits into the opening, and indicia in the lid configured to graphically display a level of beverage inside the interior volume of the beverage vessel.

### DESCRIPTION OF THE DRAWINGS

FIG. 1 is a perspective view of one embodiment of a hot beverage maker constructed according to the teachings of the present invention.

FIG. 2 is an exploded perspective view of the hot beverage maker of FIG. 1.

FIG. 3 is a cross-sectional view of the hot beverage maker of FIGS. 1-2 taken along line III-III of FIG. 1;

FIG. 4 is a perspective view of a beverage vessel for the hot beverage maker of FIGS. 1-3;

FIG. 5 is a top view of the beverage vessel of FIG. 4; and

FIG. 5 is a cross-sectional view of the beverage vessel of FIG. 4 taken along line VI-VI of FIG. 5.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION

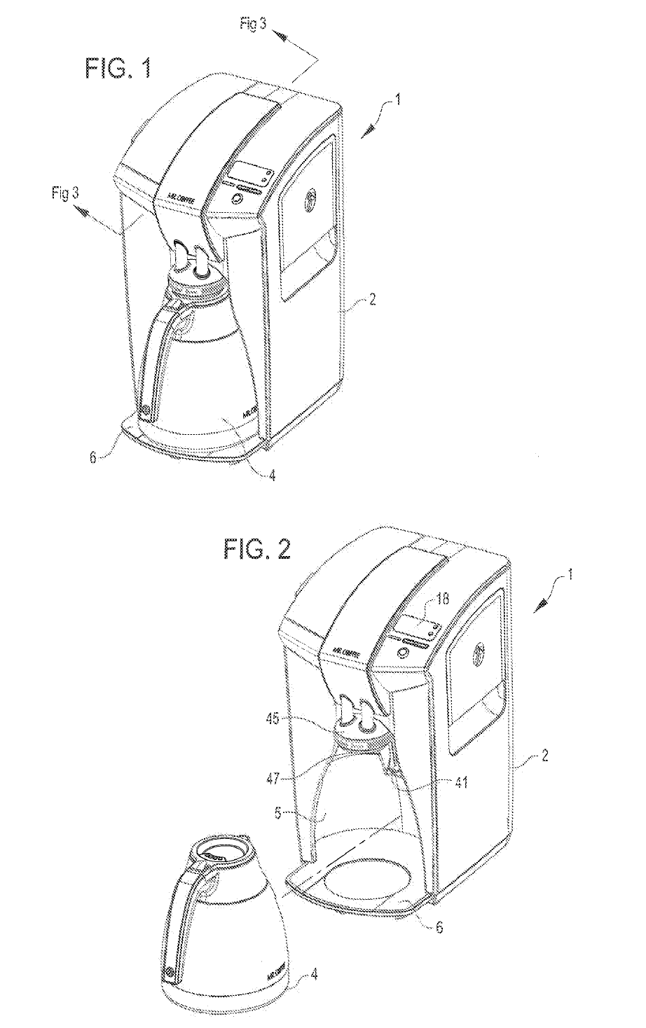

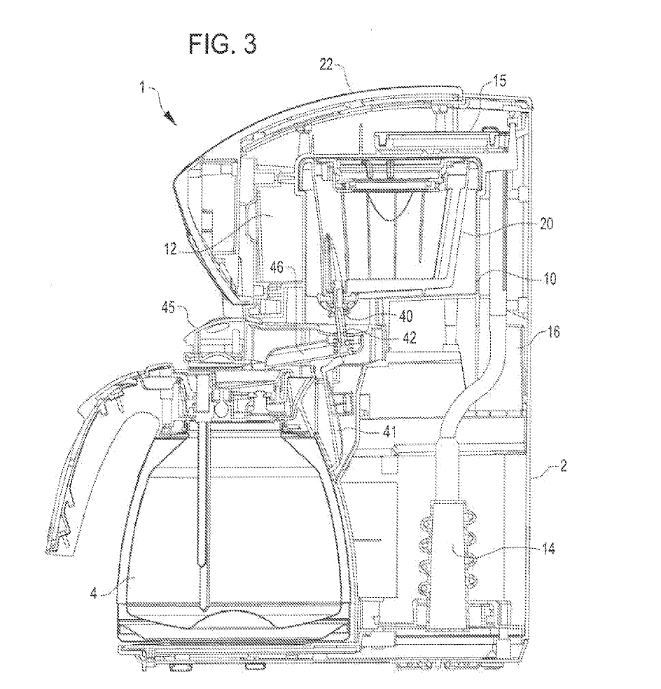

Referring now to the drawings and, more particularly, to FIGS. 1-2, a beverage maker 1 constructed according to the teachings of one embodiment of the present invention is shown including a housing 2 and a beverage vessel assembly 4. The beverage maker 1 may be for making a brewed hot beverage such as coffee, latte, cappuccino, espresso or any other beverage hot or cold. In an embodiment, the beverage vessel 4 is a thermally insulated to keep the brewed beverage inside hot. However, this is not mean to be limiting as any beverage vessel 4 including a non-thermal beverage vessel may be used as is known to one of ordinary skill in the art. The beverage vessel assembly 4 fits into a recess 5 in the housing 2 so as to allow beverage brewed in the housing 2 to drip into the beverage vessel assembly 4. A ledge 6 is disposed at the bottom of the recess 5 providing a support surface for the beverage vessel 4 when inserted into the housing 2.

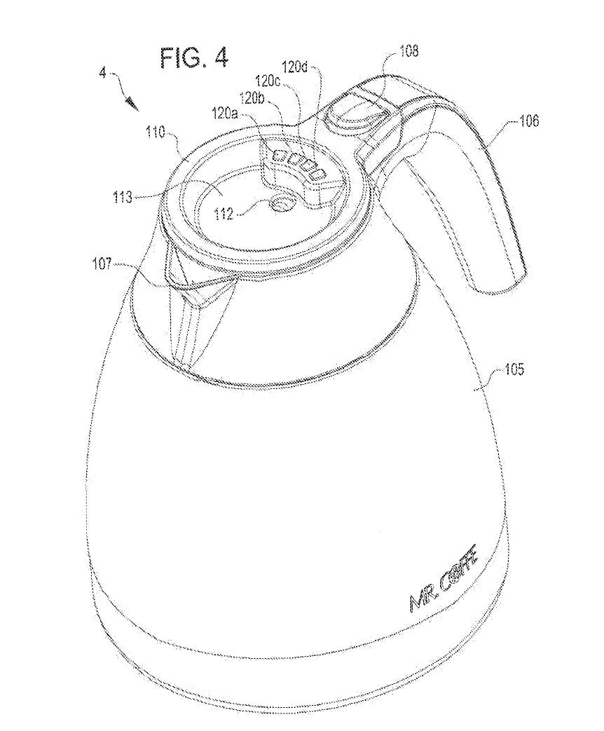

Referring now also to FIG. 3, housing 2 may include an electrical cord and plug (not shown). The electrical cord (not shown) is preferably designed to plug into a standard household 110V electrical outlet so as to supply the hot beverage maker 1 with power. However, as will be understood by one of ordinary skill in the art, the electrical cord (not shown) may be designed for electrical outlets of other shapes, types, voltages, and so forth, as may be the norm in other countries.

Housing 2 includes a brew head assembly 10 that includes a water heater assembly 14, reservoir 16 and electronic control panel 18. A brew basket 20 is generally positioned within top housing 12, but is preferably removable therefrom. Reservoir 16 is preferably separated from brew basket 20 such that liquid in reservoir 16 is not in direct contact with brew basket 20. Reservoir 16 may be shaped and contoured to at least partially surround brew basket 20. A valve assembly 40 is also positioned within the main housing 2 for controlling the flow of brewed coffee from brew basket 20 to the beverage vessel 4. A pedal 41 extending into the recess 5 is engaged when the beverage vessel 4 is inserted into the recess 5. The pedal 41 is connected via a linkage 42 to operate the valve assembly 40. Top lid 22 covers the reservoir 16, valve assembly 40, linkage 42 and brew basket 20.

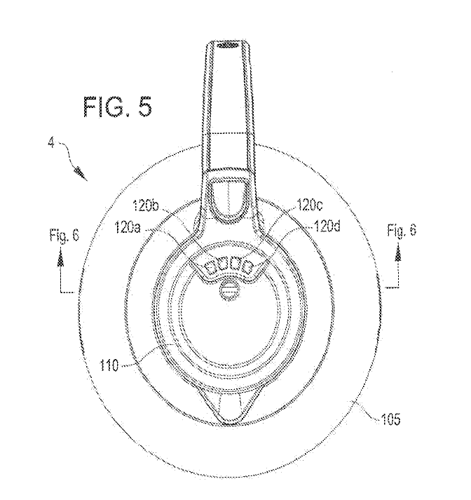

As will be understood, when coffee is to be brewed, coffee grounds are loaded into the brew basket 20, which is then inserted into brew head 10. Once water is poured into reservoir 16 and the brew cycle is activated via electronic control panel 18, water is drawn from reservoir 16 into water heater assembly 14 where it is heated. The water then travels from water heater assembly 14 through a showerhead 15 that directs the heated water into the coffee grounds contained within the brew basket 20. As shown, water heater assembly 14 heats the water which causes the water to expand and travel through connecting tubing through the shower head 15 into the brew basket 20. Alternatively, a fluid pump (not shown) or other mechanism to pump hot water separate from water heater assembly 14 may be used. The hot water seeps through the coffee grounds, and drips from the brew head 10 as brewed coffee, through valve assembly 40 to a conduit 42 within steam cap 45, and down into the beverage vessel assembly 4 for holding and storage therewithin. The steam cap 45 may include a gasket 47 to create a seal between a lid 110 (FIG. 4) of the beverage vessel assembly 4 and the steam cap 45 when the beverage vessel assembly 4 is inserted into the recess 5.

Referring now to FIG. 4, the beverage vessel assembly 4 is illustrated in additional detail. The beverage assembly 4 may include carafe 105, which may be made of glass, ceramic material, metal, or another suitable opaque or non-transparent material. The selected material may or may not be thermally insulated. The beverage vessel assembly 4 may also include the lid 110, pouring spout 107, handle 106 and a lid release button 108 embedded in the handle 106. The lid 110 fits into an opening 109 (FIG. 6) at the top of the carafe 105. The carafe 105 is formed from a bottom wall 103 (FIG. 6) and an annular sidewall 104 (FIG. 6) that ends at the opening 109 (FIG. 6). A single hole 112 is formed in lid 110 which aligns a conduit 46 within the steam cap 45 when the beverage vessel assembly 4 is positioned within the housing 2. Such an alignment allows brewed beverage from the brew basket 20 to flow from the brew basket 20 through the valve assembly 40 and the conduit 46 to within the carafe 105. The hole 112 may include a valve (not shown) biased into the closed position to prevent spillage when the beverage vessel assembly 4 is removed from the housing 2. The valve (not shown) opens under gravity when brewed beverage is flowing through the hole 112 into the carafe 105. Oppositely, when the beverage vessel assembly 4 is removed from within the housing 2 the valve assembly 40 is closed and brewed beverage is prevented from flowing from within the the brew basket 20 through the valve assembly 40 and the conduit 46 to the carafe 105. A sunken portion 113 of the lid 110 is provided to aid in collecting and directing brewed beverage flowing from conduit 46 to the hole 112 and into the carafe 105.

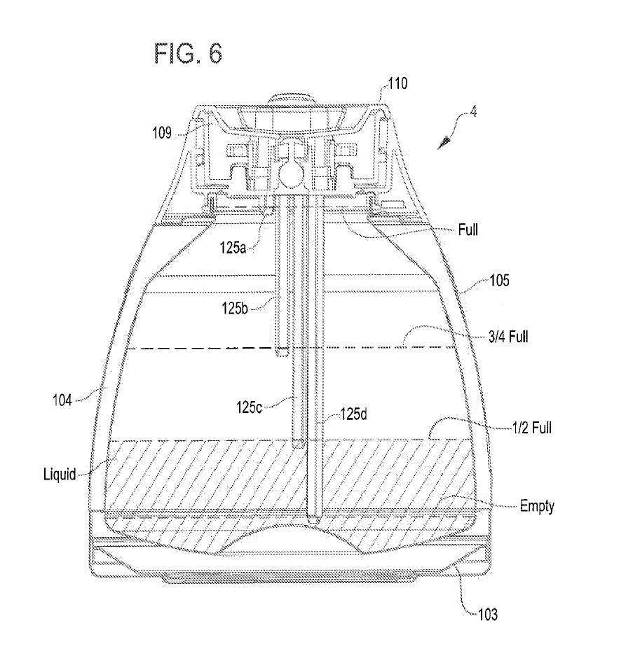

Still referring to FIG. 4 and also to FIGS. 5 and 6, disposed in the lid 120 is a plurality of beverage level indicia 120a, 120b, 120c and 120d. In the illustrated embodiment, the plurality of beverage level indicia 1.20a, 120b, 120c and 120d further include translucent light tubes 125a, 125b, 125c and 125d extending downwardly from the lid 110 into an interior volume of the carafe 105 and each having a first end end visible from the exterior of the lid 110. In another embodiment, there may a single light tube 125 and associated indicia 120. In the illustrated embodiment, each of the light tubes 125a, 125b, 125c and 125d are of varying length staggered adjacent to and spaced apart one another between the outermost light tubes 125a and 125d on opposing sides. Alternately, the light tubes 125a, 125b, 125c and 125d may be staggered directly adjacent one another with no space therebetween. In the illustrated embodiment, there is a plurality of four indicia 120 and light tubes 125 but this not meant to be limiting as there could be any number of indicia 120 and light tubes 125 associated with any variation of liquid levels within the carafe 105.

As the level of the beverage fluctuates within the carafe 105, light entering each of the light tubes 125a 125b, 125c and 125d through their first end is transmitted through the light tubes 125a, 125b, 125c and 125d and is either reflected at a opposite second angled end (when the beverage is below the height of the individual light tube 125) or absorbed into the beverage (when the beverage is at or above the height of the individual light tube 125). When the beverage level is below the height of the individual light tube 125a, 125b, 125c or 125d, the reflected light is transmitted back through the light tube 125a, 125b, 125c or 125d and out of the light tube 125a, 125b, 125c or 125d through their first end. As a result, the associated beverage level indicia 120a, 120b, 120c and 120d is seen as clear indicating the beverage level within the carafe 105 is below at least the height of that light tube 125a, 125b, 125c or 125d. Oppositely, when the beverage level is above the height of the individual light tube 125a, 125b, 125c or 125d, the reflected light is absorbed into the liquid beneath it and light is not transmitted back through the light tube 125a, 125b, 125c or 125d and back out of the light tube 125a, 125b, 125c or 125d through their first end. As a result, the associated beverage level indicia 120a, 120b, 120c or 120d is seen as darkened or unclear indicating that the beverage level within the carafe 105 is below at least the height of that light tube 125a, 125b, 125c or 125c.

The principle of operation of the light tubes 125a, 125b, 125c or 125d is well known and requires very little discussion herein. Essentially, the index of refraction at the second end of each light tube 125a, 125b, 125c and 125d is modified when the angled tip is immersed in liquid allowing light to pass unobstructed into the liquid below. In contrast, if the angled tip is not immersed in liquid it is reflected hack by the angled faces of the tip along the same ray path it traveled to the angled tip and back through the first end of the light tube 125a, 125b, 125c or 125d. The light tubes 125a, 125b, 125c or 125d may be formed from suitable light transmitting materials, such as certain types of plastic and glass but this not meant to be limiting in any sense.

An example of the foregoing operation of the plurality of indicia 120a, 120b, 120c and 120d and associated light tubes 125a, 125b, 125c and 125d to graphically display the liquid level in the carafe 105 of beverage vessel assembly 4 is illustrated in FIGS. 5 and 6. As can be seen in FIG. 6, the liquid level in the carafe 105 of beverage vessel assembly 4 is at the half-full (½) level meaning the liquid level is at or above the height of the light tubes 125c and 125d. As a result, light entering the light tubes 125c and 125d through their first end is absorbed into the liquid below and indicia 120c and 120d are seen as darkened or unclear indicating that the carafe 105 is at least at the half-full liquid level. Oppositely, light entering the light tubes 125a and 125b through the first end is reflected back through and out of the light tubes 125a and 125b through their first ends such that indicia 120a and 120b are seen as darkened or unclear indicating that the carafe 105 is below at least the full and three-quarters full (¾) liquid levels. With little reasoning it is obvious that the carafe 105 is at the half-full liquid level and that by viewing which of the indicia 120a, 120b, 120c and 120d are clear or darkened it is relatively easy to determine the liquid level within the carafe 105 without removing the lid 110.

Thus, there has been shown and described several embodiments of a beverage maker with a beverage vessel having a novel beverage level indicator. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A beverage maker, comprising:
a housing;
a brew head disposed in the housing;
a beverage vessel configured to be removably inserted into a recess in the housing and having an interior volume where beverage brewed by the brew head is directed;
a removable lid that fits into an opening of the beverage vessel leading to the interior volume; and
indicia in the cover configured to graphically display a level of beverage inside the interior volume of the beverage vessel.

2. The beverage maker of claim 1, further including a hole in the lid where beverage brewed by the brew head flows through before the brewed beverage is directed to the interior volume of the beverage vessel.

3. The beverage maker of claim 2, further including a valve disposed in the hole normally biased into the closed position and urged into the open position by brewed beverage flowing through the hole.

4. The beverage maker of claim 1, each indicia further including an associated light tube such that there is a plurality of adjacently staggered light tubes of varying length extending downwardly from the lid into the interior volume of the beverage vessel, each of said light tubes of varying lengths being associated with a particular level of beverage within the interior volume, and each of said light tubes further communicating information related to the particular level of beverage in the interior volume to the associated indicia.

5. The beverage maker of claim 4, wherein each of the light tubes have a first end attached to the cover and a second angled end that extends into the interior volume, and the light tubes where the second angled end extends below the level of liquid in the interior volume allow light entering the first end of the light tube to be absorbed by the liquid and the light tubes where the second angled end does not extend below the level of liquid in the interior volume reflect light back through the light tube and out through the first end.

6. The beverage maker of claim 1, further including a valve fluidly connected to the brew head which is actuated by a pedal depressed when the beverage vessel is inserted into the recess in the housing and configured to allow brewed beverage to flow from the brew head to the beverage vessel, and said valve is normally closed when the beverage vessel is removed from the recess in the housing.

7. The beverage maker of claim 1, further including a steam cap disposed in the recess of the housing that fits over the lid when the beverage vessel is inserted into the recess and a gasket on the steam cap that creates a seal between the steam cap and the lid.

8. The beverage maker of claim further including the beverage vessel being thermally insulated.

9. A hot beverage maker comprising:
a housing;
a brew head disposed in the housing configured to brew a hot beverage;
a thermally insulated beverage vessel configured to be removably inserted into a recess in the housing and having an interior volume where the hot beverage brewed by the brew head is directed;
a removable lid that fits into an opening of the beverage vessel leading to the interior volume; and
indicia in the cover configured to graphically display a level of beverage inside the interior volume of the beverage vessel.

10. The hot beverage maker of claim 9, further including a hole in the lid where the beverage brewed by the brew head flows through before the beverage is directed to the interior volume of the beverage vessel.

11. The hot beverage maker of claim 10, further including a valve disposed in the hole normally biased into the closed position and urged into the open position by brewed beverage flowing through the hole.

12. The hot beverage maker of claim 9, the indicia further including a plurality of adjacently staggered light tubes of varying length extending downwardly from the lid into the interior volume of the beverage vessel, each of the light tubes of varying lengths being associated with a particular level of beverage within the interior volume, and each of the light tubes further communicating information related to the particular level of beverage in the interior volume to the associated indicia.

13. The hot beverage maker of claim 12, wherein each of the light tubes have a first end attached to the cover and a second angled end that extends into the interior volume, and the light tubes where the second angled end extends below the level of liquid in the interior volume allow light entering the first end of the light tube to be absorbed by the liquid and the light tubes where the second angled end do not extend below the level of liquid in the interior volume is reflect light back through the light tube and out through the first end.

14. A beverage vessel, comprising:
a bottom wall;
an annular sidewall extending from the bottom wall and ending in an annular opening leading to an interior volume where beverage is stored for further dispensing;
a removable lid that fits into the opening; and
indicia in the lid configured to graphically display a level of beverage inside the interior volume of the beverage vessel.

15. The beverage vessel of claim 14, further including a hole in the lid where beverage brewed by a brew head of a beverage maker flows through before the beverage is directed to the interior volume of the beverage vessel.

16. The beverage vessel of claim 15, further including a valve disposed in the hole normally biased into the closed position and urged into the open position by brewed beverage flowing through the hole.

17. The beverage vessel of claim 14, the indicia including a plurality of adjacently staggered light tubes of varying length extending downwardly from the lid into the interior volume of the beverage vessel, each of the light tubes of varying lengths being associated with a particular level of beverage within the interior volume, and each of the light tubes further communicating information related to the particular level of beverage in the interior volume to the associated indicia.

18. The beverage vessel of claim 17, wherein each of the light tubes have a first end attached to the cover and a second angled end that extends into the interior volume, and the light tubes where the second angled end extends below the level of liquid in the interior volume allow light entering the first end of the light tube to be absorbed by the liquid and the light tubes where the second angled end do not extend below the level of liquid in the interior volume light reflect light back through the light tube and out through the first end.

19. The beverage vessel of claim 9, further comprising one or both of the annular sidewall and the bottom wall of the beverage vessel being formed from a non-transparent material.
